(19) United States
(12) Patent Application Publication
(10) Pub. No.: US 2025/0359537 A1
(43) Pub. Date: Nov. 27, 2025

(54) TRIAXIAL CONNECTION STRUCTURE, REPTILE BOX FRAME AND REPTILE BOX

(71) Applicant: SHENZHEN GUANGYIN LIGHTING CO., LTD, SHENZHEN CITY (CN)

(72) Inventor: HUAZHAO LONG, SHENZHEN CITY (CN)

(21) Appl. No.: 18/795,124

(22) Filed: Aug. 5, 2024

(30) Foreign Application Priority Data
May 24, 2024 (CN) 202421157492.0

(51) Int. Cl. A01K 63/00; F16B 7/04

(52) U.S. Cl. CPC A01K 63/003; F16B 7/0446

(57) ABSTRACT

A triaxial connection structure, a reptile box frame, and a reptile box relating to the technical field of connection structures are provided, including a connection body, an X-axis connection part, a Y-axis connection part, and an expansion connection part. The X-axis connection part is arranged on an X direction of the connection body and used for being fittingly engaged to a horizontal rod. The Y-axis connection part is arranged on a Y direction of the connection body and used for being fittingly engaged to a vertical rod. The expansion connection part is arranged on a Z direction of the connection body and used to cooperate with a radial force-applying component to achieve a friction locking connection with an inner tube wall of an upright rod having a tubular end.

### FIELD OF THE DISCLOSURE

The present disclosure relates to the technical field of connection structures, particularly to a triaxial connection structure, a reptile box frame, and a reptile box.

### BACKGROUND OF THE DISCLOSURE

Box enclosures for reptiles, designed specifically for housing various reptiles (Reptilia class animals and some other reptiles), are customarily structured according to the living habits and environmental needs of the housed reptiles. These enclosures generally include a reptile box frame, wall panels mounted on the reptile box frame (typically transparent wall panels), and internal systems for ventilation, heating and lighting, temperature and humidity control, feeding, and waste management. Existing reptile boxes are typically of a one-piece construction, which presents challenges in terms of transportation and makes it difficult to replace damaged components.

To address such problem, U.S. Pat. No. 5,803,019A discloses a display enclosure for reptiles and other pets, in which the display enclosure frame is formed by connecting pipes and angle connectors. This display enclosure features a modular structure that facilitates assembly and disassembly, transportation, and easy replacement of damaged parts. However, this technical solution also has some shortcomings. For instance, the three joints of the angle connector are all tubular joints, which are directly and fittingly engaged to the connecting rods. Consequently, achieving detachable connections without damaging the connecting rods and/or angle connectors typically results in lower vertical connection strength. Otherwise, there is a risk of damaging the connecting rods and/or angle connectors.

Therefore, there is a need for a triaxial connection structure, reptile box frame, and reptile box with high connection strength.

### SUMMARY OF THE DISCLOSURE

The purpose of the present disclosure is to address the defects and deficiencies of the prior art by providing a triaxial connection structure, a reptile box frame, and a reptile box, which at least solve one of the above technical problems and have the advantage of high connection strength.

In order to achieve the aforementioned purpose, the present disclosure provides a triaxial connection structure, including: a connection body, an X-axis connection part arranged in an X direction of the connection body and used for being fittingly engaged to a horizontal rod; a Y-axis connection part arranged in a Y direction of the connection body and used for being fittingly engaged to a vertical rod; and an expansion connection part arranged in a Z direction of the connection body and used to cooperate with a radial force-applying component to achieve a friction locking connection with an inner tube wall of an upright rod having a tubular end.

Preferably, the connection body is provided with a through hole along the Z direction, and the expansion connection part is an expansion sleeve coaxially arranged with the through hole and has an inner hole with a taper. The radial force-applying component is a screw passing through the through hole, and a nut is threadedly connected to the screw and relatively fixed by an inner circumference of the expansion sleeve in a rotation direction, and used for expanding or contracting the expansion sleeve during movement along a Z axis.

Preferably, a tube wall of the expansion sleeve has axial notches that are spaced apart from each other, and an inner diameter of the expansion sleeve gradually increases from a connecting end to a free end. The nut has an outer circumferential wall with a taper matching the inner diameter of the expansion sleeve to expand the expansion sleeve during downward movement along the Z axis and contract the expansion sleeve during upward movement along the Z axis.

Preferably, the expansion sleeve is in the form of a square tube, the through hole is a stepped hole, and the expansion sleeve is arranged on a smaller-diameter side of a stepped hole.

Preferably, the triaxial connection structure further includes a plug cover. A plug hole is coaxially provided on a side of the stepped hole away from the expansion sleeve, and the plug cover is inserted into the plug hole to cover the screw.

Preferably, at least one of the X-axis connection part and/or the Y-axis connection part is an insertion protrusion formed by protruding outward from the connection body, and a free end of the insertion protrusion has a guiding chamfer.

Preferably, at least one of the X-axis connection part and the Y-axis connection part has slots that are spaced apart from each other along an axial direction.

Preferably, at least one of the X-axis connection part and the Y-axis connection part has reinforcing ribs arranged axially on a side away from the slots.

The present disclosure further provides a reptile box frame, including a plurality of horizontal rods, a plurality of vertical rods, a plurality of upright rods, the aforementioned triaxial connection structure, and a radial force-applying component matching the triaxial connection structure. Two ends of a same horizontal rod are respectively connected to the X-axis connection parts of adjacent triaxial connection structures, two ends of a same vertical rod are respectively connected to the Y-axis connection parts of adjacent triaxial connection structures, and two ends of a same upright rod are respectively connected to the expansion connection parts of adjacent triaxial connection structures in cooperation with the radial force-applying component.

The present disclosure further provides a reptile box, including the aforementioned reptile box frame, and wall panels arranged on the reptile box frame.

The advantages of the present disclosure compared to prior art are as follows.

The triaxial connection structure provided by the present disclosure has the expansion part arranged in the Z direction of the connection body, so as to cooperate with the radial force-applying component to create the friction locking connection with the inner wall of the tubular end of the upright rod. When the expansion connection part expands, it tightly adheres to the inner wall of the upright rod to generate a significant frictional force and mechanical interlocking force that secure the expansion connection part within the upright rod. The present disclosure offers the advantage of high connection strength in the technical solution.

### BRIEF DESCRIPTION OF THE DRAWINGS

To more clearly illustrate the technical solutions of the embodiments of the present disclosure or the prior art, the following is a brief introduction to the drawings needed for the description of the embodiments or the prior art. It is evident that the drawings described below are merely some embodiments of the present disclosure. For those skilled in the art, other drawings can be obtained based on the provided drawings without creative efforts.

FIG. 1 is a schematic exploded view of a horizontal rod, a vertical rod, an upright rod, and a radial force-applying component of an embodiment of the present disclosure.

FIG. 2 is a schematic exploded view of the radial force-applying component the embodiment of the present disclosure.

FIG. 3 is a schematic axial perspective view of one angle of the embodiment of the present disclosure.

FIG. 4 is a schematic axial perspective view of another angle of the embodiment of the present disclosure.

FIG. 5 is a schematic top view of the embodiment of the present disclosure.

FIG. 6 is a sectional view taken along the line A-A in FIG. 5.

Reference numeral: 100, triaxial connection structure; 1, connection body; a, stepped hole; b, plug hole; 2, X-axis connection part; 3, Y-axis connection part; 4, expansion sleeve; c: axial notch; 41, expansion strip; 5, guide chamfer; 6, slot; 7, reinforcing rib; 8, screw; 9, nut; 200, horizontal rod; 300, vertical rod; 400, upright rod.

### DETAILED DESCRIPTION OF THE EXEMPLARY EMBODIMENTS

The technical solutions of the embodiments of the present disclosure will be clearly and completely described below in conjunction with the accompanying drawings. It is apparent that the described embodiments are only part of the embodiments of the present disclosure, not all of them. Based on the embodiments of the present disclosure, all other embodiments obtained by those skilled in the art without making creative efforts belong to the scope of protection of the present disclosure.

It should be noted that the terms “center,” “longitudinal,” “transverse,” “upper,” “lower,” “front,” “rear,” “left,” “right,” “top,” “bottom,” “inner,” “outer,” “back,” “side,” “circumferential” and the like indicating directions or positional relationships are based on the positional relationships shown in the drawings, and are merely for the purpose of describing the present disclosure and simplifying the description, rather than indicating or implying that the device or element must have a specific orientation, be constructed in a specific orientation, and operated in a specific orientation, and therefore should not be construed as limiting the present disclosure. Additionally, terms like “first” and “second” are used for descriptive purposes only and should not be construed as indicating or implying relative importance or implicitly specifying the number of technical features indicated.

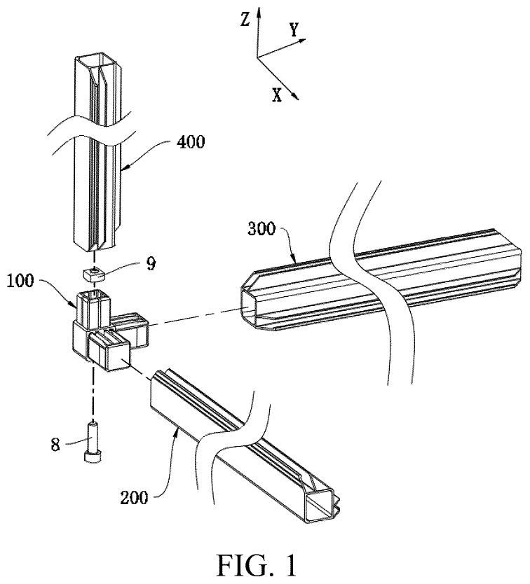

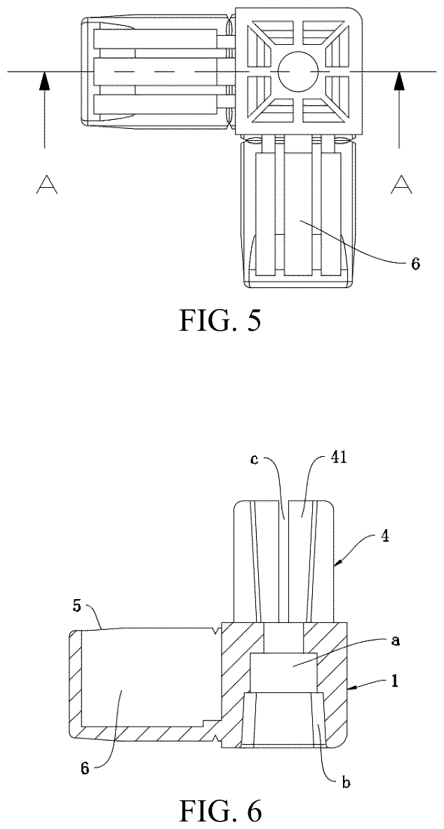

Referring to FIG. 1 to FIG. 6, an embodiment of the present disclosure provides a triaxial connection structure 100, including: a connection body 1, an X-axis connection part 2, a Y-axis connection part 3, and an expansion connection part. To facilitate understanding, please refer to FIG. 1, where an extending direction of the X-axis connection part 2 is defined as an X direction, an extending direction of the Y-axis connection part 3 is defined as a Y direction, and an extending direction of the expansion connection part is defined as a Z direction. The connection body 1 has a cubic structure, and its three external edges are rounded to reduce a risk of scratching the user. The X-axis connection part 2 is arranged in the X direction of the connection body 1 for being fittingly engaged to a horizontal rod 200. The Y-axis connection part 3 is arranged in the Y direction of the connection body 1 for being fittingly engaged to a vertical rod 300. The expansion connection part is arranged in the Z direction of the connection body 1 to cooperate with a radial force-applying component (not shown in the figures) for a friction locking connection with an inner wall of an upright rod 400 having a tubular end. Specifically, the expansion connection part is an element that can expand radially under force to create a significant friction or interlocking force with the inner wall of the upright rod 400 having the tubular end. In the present embodiment, the connection body 1, the X-axis connection part 2, the Y-axis connection part 3, and the expansion connection part are integrally formed by plastic injection molding, and then processed by cutting. Certainly, in other embodiments, the connection body 1, the X-axis connection part 2, the Y-axis connection part 3, and the expansion connection part can also be made of the same or different materials and assembled together by fasteners or snaps, but the present disclosure is not limited thereto.

The connection body 1 of the triaxial connection structure 100 in the Z direction is provided with the expansion connection part used to cooperate with the radial force-applying component to achieve the friction locking connection with the inner wall of the upright rod 400 having the tubular end. As the expansion connection part tightly fits against the inner wall of the vertical rod 400 when expanded, it generates the significant amount of frictional force and mechanical interlocking force to fix the expansion connection part within the upright rod 400, so as to provide the technical solution with the advantage of high connection strength.

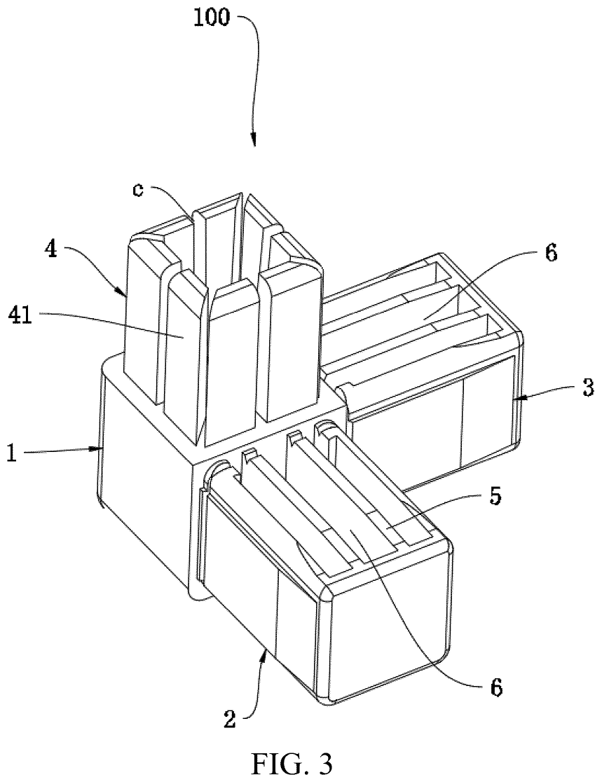

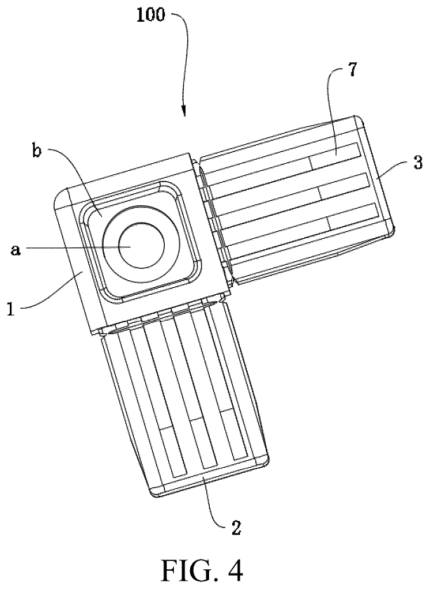

Referring to FIG. 1, FIG. 3, FIG. 4, and FIG. 6, in the present embodiment, to achieve a detachable connection between the expansion connection part and the upright rod 400 having the tubular end, optionally the connection body 1 is provided with a through hole in the Z direction. Specifically, the through-hole is a stepped hole a. The expansion connection part is an expansion sleeve 4. The radial force-applying component includes a screw 8 and a nut 9. The expansion sleeve 4, of which an inner hole with a taper, is coaxially arranged with the stepped hole a and arranged on a side with a smaller diameter of the stepped hole a. The screw 8 passes through the through hole, with a shaft of the screw 8 passing through the stepped hole a of the connection body 1, and a head of the screw 8 being restricted at a larger diameter end of the stepped hole a. The nut 9 is threadedly connected to the screw 8, and is rotationally fixed relative to an inner circumference of the expansion sleeve 4 and used to expand or contract the expansion sleeve 4 as the nut 9 moves along a Z-axis. That is, the nut 9 is preset on the inner circumference of the expansion sleeve 4, and the nut 9 cannot rotate relative to the expansion sleeve 4. Therefore, when the screw 8 and the nut 9 are matched, rotating the screw 8 allows the nut 9 to move along the Z-axis. Since the inner hole of the expansion sleeve 4 is tapered, rotating the screw 8 in one direction moves the nut 9 towards an end with the smaller inner diameter of the expansion sleeve 4 to gradually expand the expansion sleeve 4, so that the expansion sleeve 4 can tightly fit against the inner wall of the upright rod 400. Rotating the screw 8 in the opposite direction moves the nut 9 towards an end with the larger inner diameter of the expansion sleeve 4 to gradually contract the expansion sleeve 4, so that the friction between the expansion sleeve 4 and the inner wall of the vertical rod 400 can be reduced. Thus, the expansion connection part achieves a detachable connection with the upright rod 400 having the tubular end. In the present embodiment, an outer diameter of the threaded part of the screw 8 should be smaller than the inner diameter of the expansion sleeve 4 to avoid interference between the screw 8 and the inner wall of the expansion sleeve 4, so as to prevent the cutting of the inner wall of the expansion sleeve 4 during rotation.

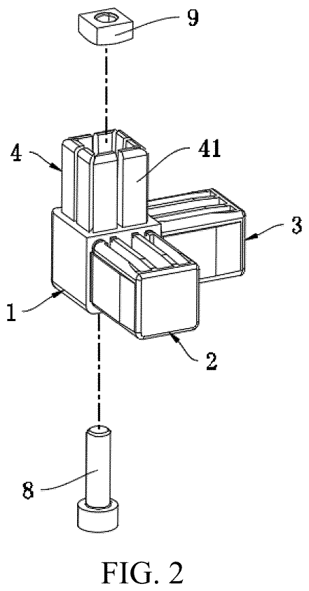

Optionally, referring to FIG. 2, FIG. 3, and FIG. 6, in the present embodiment, a wall of the expansion sleeve 4 has spaced axial notches c, meaning that the expansion sleeve 4 includes a plurality of expansion strips 41 arranged coaxially and at intervals. The inner diameter of the expansion sleeve 4 increases gradually from a connection end to a free end, forming an inverted cone shape for the inner hole of the expansion sleeve 4. Correspondingly, the nut 9 has an outer circumferential wall with a taper matching the inner diameter of the expansion sleeve 4, which allows better movement along the Z-axis, so as to enable the nut 9 to expand the expansion sleeve 4 when moving downwards along the Z-axis and contract the expansion sleeve 4 when moving upwards along the Z-axis. In other embodiments, the inner diameter of the expansion sleeve 4 can also decrease gradually from the connection end to the free end, so as to form a conical shape for the inner hole of the expansion sleeve 4, with the nut 9 having the outer circumferential wall with a matching taper. This allows the nut 9 to expand the expansion sleeve 4 when moving upwards along the Z-axis and contract the expansion sleeve 4 when moving downwards along the Z-axis, but the present disclosure is not limited thereto. Additionally, in other embodiments, the radial force-applying component can have the nut 9 arranged at the end with the larger diameter of the stepped hole a, with the screw 8 having a plain shaft portion with a taper matching the inner diameter of the expansion sleeve 4. Rotating the nut 9 moves the screw 8 up and down, and the plain shaft portion of the screw 8 is used to expand or contract the expansion sleeve 4, so as to achieve the detachable connection between the expansion connection part and the upright rod 400 having the tubular end.

Optionally, referring to FIG. 3, in the present embodiment, the expansion sleeve 4 is square-tubed, but in other embodiments, the expansion sleeve 4 can also be round-tubed or have other polygonal shapes to fit upright rods 400 with different tubular ends.

Referring to FIG. 4 and FIG. 6, in the present embodiment, to prevent the assembled screw 8 from rusting due to moisture or collecting dust, optionally the triaxial connection structure 100 further includes a plug cover (not shown in the figures). A plug hole b is coaxially provided on a side of the stepped hole a away from the expansion sleeve 4, and the plug cover is inserted into the plug hole b to cover the screw 8.

Optionally, the X-axis connection part 2 can be detachably or fixedly connected to the horizontal rod 200, and the Y-axis connection part 3 can be detachably or fixedly connected to the vertical rod 300, but the present disclosure is not limited thereto. Specifically, referring to FIG. 1 and FIG. 3, in the present embodiment, the X-axis connection part 2 and/or the Y-axis connection part 3 are insertion protrusions formed by protruding from the connection body 1, and a free end of the insertion protrusion has a guide chamfer 5. Thus, the X-axis connection part 2 can be quickly inserted and assembled with the horizontal rod 200 having a tubular end, and the Y-axis connection part 3 can be quickly inserted and assembled with the vertical rod 300 having a tubular end. Certainly, the X-axis connection part 2 and/or the Y-axis connection part 3 can also be threaded structures to achieve threaded connections with horizontal rods 200 and/or vertical rods 300 having matching threaded structures. Similarly, the X-axis connection part 2 and/or the Y-axis connection part 3 can also be concave structures to be connected with rods having protrusions.

Optionally, referring to FIG. 3 and FIG. 6, in the present embodiment, each of the X-axis connection part 2 and the Y-axis connection part 3 has three slots 6 that are spaced apart from each other along an axial direction. In other embodiments, a number of slots 6 can also be one, two, four, or more, depending on specific size settings. The slots 6 can also be set only on the X-axis connection part 2 or only on the Y-axis connection part 3. To increase strength on a side opposite to a bottom wall of the slot 6, further, the X-axis connection part 2 and/or the Y-axis connection part 3 are provided with reinforcing ribs 7 along the axial direction on a side away from an opening of the slot 6.

Another aspect of the present disclosure also provides a reptile box frame (not shown in the figures), including a plurality of horizontal rods 200, a plurality of vertical rods 300, a plurality of upright rods 400, the above-mentioned triaxial connection structure 100, and a radial force-applying component that cooperates with the triaxial connection structure 100. Two ends of the same horizontal rod 200 are respectively connected to the X-axis connection parts 2 of adjacent triaxial connection structures 100, two ends of the same vertical rod 300 are respectively connected to the Y-axis connection parts 3 of adjacent triaxial connection structures 100, and two ends of the same upright rod 400 are respectively assembled with the expansion connection parts of adjacent triaxial connection structures 100 under the cooperation of the radial force-applying component.

Since the reptile box frame possesses all the structures and connection relationships of the triaxial connection structure 100, it has all the advantages of the triaxial connection structure 100, which will not be reiterated herein.

Another aspect of the present disclosure further provides a reptile box (not shown in the figures), including the aforementioned reptile box frame and wall panels (not shown in the figures) arranged on the reptile box frame. Since the reptile box possesses all the structures and connection relationships of the reptile box frame, it has all the advantages of the reptile box frame, which will not be reiterated herein.

Finally, it should be noted that the above embodiments are only for illustrating the technical solutions of the present disclosure and not for limiting them. Although the present disclosure has been described in detail with reference to the above embodiments, those skilled in the art should understand that they can still modify the technical solutions described in the above embodiments or make equivalent replacements of some or all of the technical features. These modifications or replacements do not depart from the essence of the technical solutions of the embodiments of the present disclosure.

What is claimed is:

1. A triaxial connection structure, comprising:
a connection body (1),
an X-axis connection part (2), arranged in an X direction of the connection body (1) and used for being fittingly engaged to a horizontal rod (200);
a Y-axis connection part (3), arranged in a Y direction of the connection body (1) and used for being fittingly engaged to a vertical rod (300); and
an expansion connection part, arranged in a Z direction of the connection body (1) and used to cooperate with a radial force-applying component to achieve a friction locking connection with an inner tube wall of an upright rod (400) having a tubular end.

2. The triaxial connection structure according to claim 1, wherein the connection body (1) is provided with a through hole along the Z direction; wherein the expansion connection part is an expansion sleeve (4) coaxially arranged with the through hole and has an inner hole with a taper; wherein the radial force-applying component is a screw (8) passing through the through hole, and a nut (9) is threadedly connected to the screw (8) and relatively fixed by an inner circumference of the expansion sleeve (4) in a rotation direction, and used for expanding or contracting the expansion sleeve (4) during movement along a Z axis.

3. The triaxial connection structure according to claim 2, wherein a tube wall of the expansion sleeve (4) has axial notches (c) that are spaced apart from each other, and an inner diameter of the expansion sleeve (4) gradually increases from a connecting end to a free end; wherein the nut (9) has an outer circumferential wall with a taper matching the inner diameter of the expansion sleeve (4) to expand the expansion sleeve (4) during downward movement along the Z axis and contract the expansion sleeve (4) during upward movement along the Z axis.

4. The triaxial connection structure according to claim 3, wherein the expansion sleeve (4) is in the form of a square tube, the through hole is a stepped hole (a), and the expansion sleeve (4) is arranged on a smaller-diameter side of a stepped hole (a).

5. The triaxial connection structure according to claim 4, further comprising a plug cover, wherein a plug hole (b) is coaxially provided on a side of the stepped hole (a) away from the expansion sleeve (4), and the plug cover is inserted into the plug hole (b) to cover the screw (8).

6. The triaxial connection structure according to claim 1, wherein at least one of the X-axis connection part (2) and the Y-axis connection part (3) is an insertion protrusion formed by protruding outward from the connection body (1), and a free end of the insertion protrusion has a guiding chamfer (5).

7. The triaxial connection structure according to claim 6, wherein at least one of the X-axis connection part (2) and the Y-axis connection part (3) has slots (6) that are spaced apart from each other along an axial direction.

8. The triaxial connection structure according to claim 7, wherein at least one of the X-axis connection part (2) and the Y-axis connection part (3) has reinforcing ribs (7) arranged axially on a side away from the slots (6).

9. A reptile box frame, comprising a plurality of horizontal rods (200), a plurality of vertical rods (300), a plurality of upright rods (400), the triaxial connection structure as claimed in claim 1, and a radial force-applying component matching the triaxial connection structure, wherein two ends of a same horizontal rod (200) are respectively connected to the X-axis connection parts (2) of adjacent triaxial connection structures, two ends of a same vertical rod (300) are respectively connected to the Y-axis connection parts (3) of adjacent triaxial connection structures, and two ends of a same upright rod (400) are respectively connected to the expansion connection parts of adjacent triaxial connection structures in cooperation with the radial force-applying component.

10. A reptile box frame, comprising a plurality of horizontal rods (200), a plurality of vertical rods (300), a plurality of upright rods (400), the triaxial connection structure as claimed in claim 2, and a radial force-applying component matching the triaxial connection structure, wherein two ends of a same horizontal rod (200) are respectively connected to the X-axis connection parts (2) of adjacent triaxial connection structures, two ends of a same vertical rod (300) are respectively connected to the Y-axis connection parts (3) of adjacent triaxial connection structures, and two ends of a same upright rod (400) are respectively connected to the expansion connection parts of adjacent triaxial connection structures in cooperation with the radial force-applying component.

11. A reptile box frame, comprising a plurality of horizontal rods (200), a plurality of vertical rods (300), a plurality of upright rods (400), the triaxial connection structure as claimed in claim 3, and a radial force-applying component matching the triaxial connection structure, wherein two ends of a same horizontal rod (200) are respectively connected to the X-axis connection parts (2) of adjacent triaxial connection structures, two ends of a same vertical rod (300) are respectively connected to the Y-axis connection parts (3) of adjacent triaxial connection structures, and two ends of a same upright rod (400) are respectively connected to the expansion connection parts of adjacent triaxial connection structures in cooperation with the radial force-applying component.

12. A reptile box frame, comprising a plurality of horizontal rods (200), a plurality of vertical rods (300), a plurality of upright rods (400), the triaxial connection structure as claimed in claim 4, and a radial force-applying component matching the triaxial connection structure, wherein two ends of a same horizontal rod (200) are respectively connected to the X-axis connection parts (2) of adjacent triaxial connection structures, two ends of a same vertical rod (300) are respectively connected to the Y-axis connection parts (3) of adjacent triaxial connection structures, and two ends of a same upright rod (400) are respectively connected to the expansion connection parts of adjacent triaxial connection structures in cooperation with the radial force-applying component.

13. A reptile box frame, comprising a plurality of horizontal rods (200), a plurality of vertical rods (300), a plurality of upright rods (400), the triaxial connection structure as claimed in claim 5, and a radial force-applying component matching the triaxial connection structure, wherein two ends of a same horizontal rod (200) are respectively connected to the X-axis connection parts (2) of adjacent triaxial connection structures, two ends of a same vertical rod (300) are respectively connected to the Y-axis connection parts (3) of adjacent triaxial connection structures, and two ends of a same upright rod (400) are respectively connected to the expansion connection parts of adjacent triaxial connection structures in cooperation with the radial force-applying component.

14. A reptile box, comprising the reptile box frame as claimed in claim 9, and wall panels arranged on the reptile box frame.
